(19) United States
(12) Patent Application Publication
(10) Pub. No.: US 2018/0322771 A1
(43) Pub. Date: Nov. 8, 2018

(54) SAFETY SYSTEM INSPECTION APPARATUS AND METHOD

(71) Applicant: Charles Kilfoil, West Richland, WA (US)

(72) Inventor: Charles Kilfoil, West Richland, WA (US)

(21) Appl. No.: 15/589,890

(22) Filed: May 8, 2017

(51) Int. Cl. G08B 29/14; G05D 1/00; G05D 1/02; B64C 39/02

(52) U.S. Cl. CPC G08B 29/145; G05D 1/0088; B64C 2201/12; B64C 39/02; G05D 1/0202

(57) ABSTRACT

An apparatus and system for performing inspections including a drone having circuitry configured to communicate wirelessly with automated fire safety systems. A homing device may be attached to the drone, and the system may further include a second drone with a camera, such that the second drone may detect the homing device and follow and record the first drone's operations with the camera.

### TECHNICAL FIELD

This invention relates generally to improvements in methods and devices for inspecting safety systems. Among other uses, the present invention may provide an improved apparatus and method for inspecting fire safety systems.

### BACKGROUND OF THE INVENTION

The Life Safety Code, known as NFPA 101, is a consensus standard widely adopted in the United States that addresses “those construction, protection, and occupancy features necessary to minimize danger to life from the effects of fire, including smoke, heat, and toxic gases created during a fire.” It is published by the National Fire Protection Association NFPA. Some or all of the features described in NFPA 101 have been adopted as law in the fire safety codes of many jurisdictions throughout the United States. Among other fire safety systems, NFPA 101 describes energized fire suppression systems, fire barriers including openings, fire alarm systems, emergency egress systems, HVAC Systems including dampers, and mass notification systems. Within the safety codes of many jurisdictions in the United States, periodic inspections of these and other systems are required to insure their continued functionality and operability.

Generally speaking, the inspection of these systems is performed manually by human inspectors. Manual inspections create many drawbacks. For example, and not meant to be limiting, many of the systems that need to be inspected are in locations that are difficult to access for fire safety inspectors. There is a need for new devices and methods of performing inspections that overcome the drawbacks of performing manual inspections. Among other advantages, and not meant to be limiting, the present invention provides the capability to automate the manual inspection process.

### SUMMARY OF THE INVENTION

The present invention may include an apparatus for performing inspections including a drone having circuitry configured to communicate wirelessly with automated fire safety systems. While not meant to be limiting, the automated fire safety systems may include fire alarm panels, notification devices, alarming devices, operator devices, heat detecting devices, energized fire suppression systems, fire barriers including openings, fire alarm systems, emergency egress systems, HVAC systems including dampers and mass notification systems. The fire alarm panels, notification devices, alarming devices, operator devices, heat detecting devices, smoke detecting devices, energized fire suppression systems, fire barriers including openings, fire alarm systems, emergency egress systems, HVAC systems including dampers and mass notification systems may include circuitry configured to read and communicate their state to the drone. While not meant to be limiting, the circuitry configured to communicate wirelessly with the automated fire safety systems may be selected as bluetooth wireless systems and wifi wireless systems. The drone may further include circuitry configured to ascertain the drones geospacial location utilizing a global positioning system and further configured to record and repeat a pattern of flight and inspection controlled by an operator. The drone may further include circuitry configured to read a barcode affixed to a fire safety system. The circuitry configured to read a barcode may include a digital camera, a photodiode paired with a light source, a laser scanner, a light emitting diode scanner, and an omnidirectional scanner. The drone may further include a device capable of directing heat to a fire safety system. The present invention may include a homing device attached to the drone, and may further include a second drone. The second drone may include a camera, and the second drone may include circuitry configured to detect the homing device and to direct the second drone to follow the drone and record its operations with the camera.

### BRIEF DESCRIPTION OF THE DRAWINGS

The following detailed description of the embodiments of the invention will be more readily understood when taken in conjunction with the following drawings, wherein:

FIG. 1 is an illustration of an example of the apparatus of the present invention.

FIG. 2 is an illustration of an example of the apparatus of the present invention.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

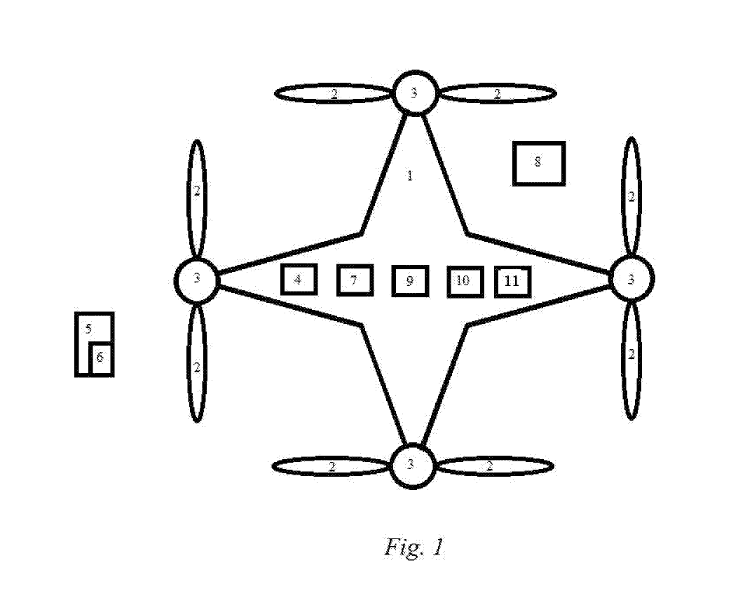

One exemplary embodiment of the present invention is shown in FIG. 1.

As shown in FIG. 1, the present invention may include a drone 1. As shown in FIG. 1, the drone 1 has four propellers 2, each powered by an independent motor 3. While a drone 1 having four propellers 2 and four motors 3. is shown in FIG. 1, the present invention should in no way be limited to such configurations, as drones with fewer or more propellers 2 and motors 3 are contemplated herein. The drone shown in FIG. 1 further includes circuitry 4 configured to communicate wirelessly with automated fire safety systems 5, including, but not limited to, fire alarm panels, notification devices, alarming devices, operator devices, heat detecting devices, energized fire suppression systems, fire barriers including openings, fire alarm systems, emergency egress systems, HVAC systems including dampers and mass notification systems. As further shown in FIG. 1, the automated fire safety systems 5, including but not limited to fire alarm panels, notification devices, alarming devices, operator devices, heat detecting devices, smoke detecting devices, energized fire suppression systems, fire barriers including openings, fire alarm systems, emergency egress systems, HVAC systems including dampers and mass notification systems may also include circuitry 6 configured to read and communicate their state to the drone.

The automated fire safety systems 5 fire alarm panels may include automated features that allow interaction with the drone 1. As an example, and not meant to be limiting, the fire alarm panel may include the ability to record the results of testing of the various systems connected to the fire alarm panel, and the ability to first record those results and then communicate the results of those tests to the drone 1.

The automated fire safety systems 5 fire suppression systems may include electro-mechanical features that will activate due to instructions sent by the drone 1. As an example, and not meant to be limiting, the fire suppression system may include the ability to collect data on system static and residual pressure, GPM flowing, discharge rates, and actuation times. This data may then be communicated to the drone 1.

The fire safety systems 5 fire dampers may be electro-mechanically actuated based on commands received from the drone 1. Open and Closed positions may be recorded and documented by the drone 1 in this manner. Output responses may be processed and organized by software in drone 1.

While not meant to be limiting, the circuitry 4 configured to communicate wirelessly with the automated fire safety systems 5 may be selected as bluetooth wireless systems and wifi wireless systems.

Also shown in FIG. 1, the drone may further include circuitry 7 configured to ascertain the drones geospacial location utilizing a global positioning system (GPS) 8. In this manner, the drone may be configured to record and repeat a pattern of flight and inspection controlled by an operator.

The drone may further include a laser measuring system 11. Both the laser measuring system 11 and the GPS 8 may also allow the drone 1 to make accurate measurements of spacing between devices such as smoke and heat detectors, fire sprinkler heads, distances from walls to such devices, mapping and recording of egress distances for building evacuations, and separation of structures. GPS 8 may also allow the drone 1 to map and record the layouts of devices, systems and structures.

Also shown in FIG. 1, the drone may further include circuitry 9 configured to read a barcode affixed to a fire safety system. The circuitry 9 configured to read a barcode may include a digital camera, a photodiode paired with a light source, a laser scanner, a light emitting diode scanner, and an omnidirectional scanner.

Barcoding of items will provide manufacture information to the device regarding construction, listing and function of component. Barcoding of items will allow the device to track and maintain records of completion for equipment, systems and facilities. Barcoding will also initiate commands within the device to actuate systems and devices.

Also shown in FIG. 1, the drone may further include a device 10 capable of directing heat to a fire safety system.

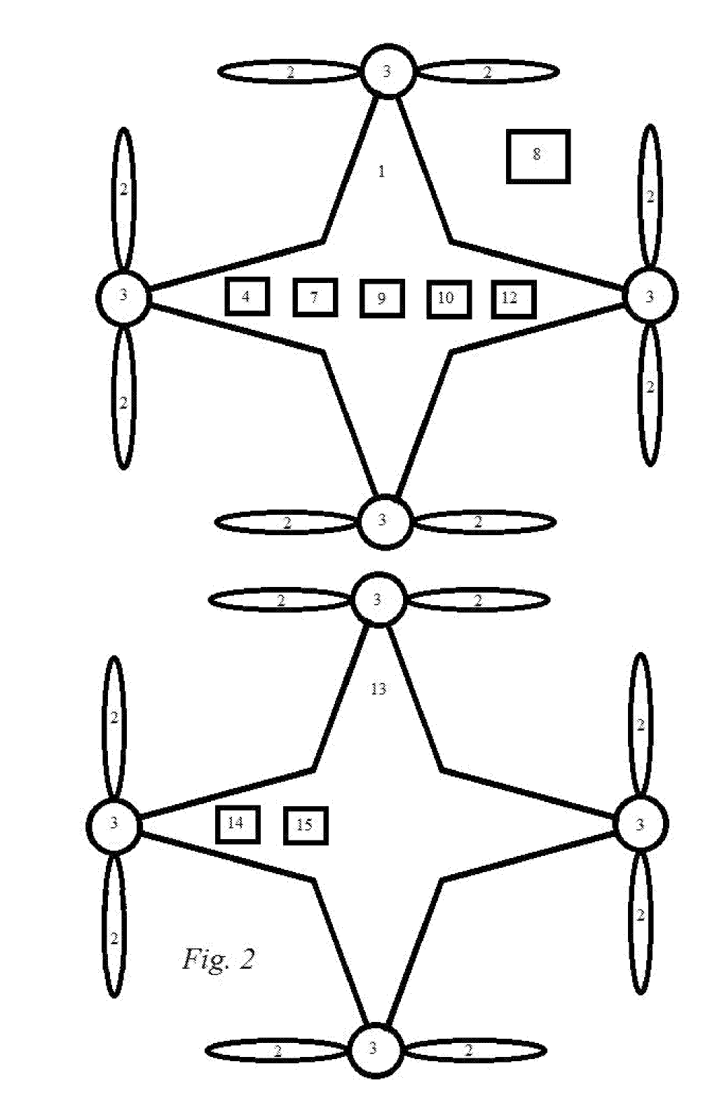

As shown in FIG. 2, the present invention may include a homing device 12 attached to the drone 1, and may further include a second drone 13. The second drone 13 may include a camera 14, and the second drone 13 may include circuitry 15 configured to detect the homing device 12 and to direct the second drone 13 to follow the drone 1 and record its operations with the camera 14.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Likewise, where the term “input” or “output” is used in connection with an electric device or fluid processing unit, it should be understood to comprehend singular or plural and one or more signal channels or fluid lines as appropriate in the context. Finally, all publications, patents, and patent applications cited in this specification are herein incorporated by reference to the extent not inconsistent with the present disclosure as if each were specifically and individually indicated to be incorporated by reference and set forth in its entirety herein.

What is claimed is:

1. An apparatus for performing inspections comprising a drone having circuitry configured to communicate wirelessly with automated fire safety systems.

2. The apparatus of claim 1 wherein the automated fire safety systems are selected from fire alarm panels, notification devices, alarming devices, operator devices, heat detecting devices, energized fire suppression systems, fire barriers including openings, fire alarm systems, emergency egress systems, HVAC systems including dampers and mass notification systems.

3. The apparatus of claim 1 wherein the circuitry configured to communicate wirelessly with the automated fire safety systems are selected from bluetooth wireless systems and wifi wireless systems.

4. The apparatus of claim 1 wherein the drone further includes circuitry configured to ascertain the drones geospacial location utilizing a global positioning system and further configured to record and repeat a pattern of flight and inspection controlled by an operator.

5. The apparatus of claim 1 wherein the drone further includes circuitry configured to read a barcode affixed to a fire safety system.

6. The apparatus of claim 1 wherein the drone further includes a device capable of directing heat to a fire safety system.

7. The apparatus of claim 7 wherein the circuitry configured to read a barcode is selected from a digital camera, a photodiode paired with a light source, a laser scanner, a light emitting diode scanner, and an omnidirectional scanner.

8. The apparatus of claim 1 wherein the drone further includes a laser measuring system.

9. The apparatus of claim 1 further comprising a homing device attached to the drone, a second drone and wherein the second drone includes a camera, wherein the second drone includes circuitry configured to detect the homing device and to direct the second drone to follow the drone and record its operations with the camera.

10. The apparatus of claim 1 wherein the fire alarm panels, notification devices, alarming devices, operator devices, heat detecting devices, smoke detecting devices, energized fire suppression systems, fire barriers including openings, fire alarm systems, emergency egress systems, HVAC systems including dampers and mass notification systems are include circuitry configured to read and communicate their state to the drone.

11. An apparatus for performing inspections comprising a drone having circuitry configured to communicate wirelessly with automated fire safety systems and a homing device attached to the drone, a second drone and wherein the second drone includes a camera, wherein the second drone includes circuitry configured to detect the homing device and to direct the second drone to follow the drone and record its operations with the camera.

12. The apparatus of claim 11 wherein the automated fire safety systems are selected from fire alarm panels, notification devices, alarming devices, operator devices, heat detecting devices, energized fire suppression systems, fire barriers including openings, fire alarm systems, emergency egress systems, HVAC systems including dampers and mass notification systems.

13. The apparatus of claim 11 wherein the circuitry configured to communicate wirelessly with the automated fire safety systems are selected from bluetooth wireless systems and wifi wireless systems.

14. The apparatus of claim 11 wherein the drone further includes circuitry configured to ascertain the drones geospacial location utilizing a global positioning system and further configured to record and repeat a pattern of flight and inspection controlled by an operator.

15. The apparatus of claim 11 wherein the drone further includes circuitry configured to read a barcode affixed to a fire safety system.

16. The apparatus of claim 10 wherein the drone further includes a device capable of directing heat to a fire safety system.

17. The apparatus of claim 11 wherein the drone further includes circuitry configured to read a barcode affixed to a fire safety system.

18. The apparatus of claim 17 wherein the circuitry configured to read a barcode is selected from a digital camera, a photodiode paired with a light source, a laser scanner, a light emitting diode scanner, and an omnidirectional scanner.

19. The apparatus of claim 11 wherein the drone further includes a laser measuring system.

20. The apparatus of claim 11 wherein the fire alarm panels, notification devices, alarming devices, operator devices, heat detecting devices, smoke detecting devices, energized fire suppression systems, fire barriers including openings, fire alarm systems, emergency egress systems, HVAC systems including dampers and mass notification systems are include circuitry configured to read and communicate their state to the drone.
